(19) United States
(12) Patent Application Publication
(10) Pub. No.: US 2011/0222119 A1
(43) Pub. Date: Sep. 15, 2011

(54) COLORING BOOK DESIGNER KIT

(76) Inventor: Reuben David JARVIS, Thorold (CA)

(21) Appl. No.: 13/046,252

(22) Filed: Mar. 11, 2011

Related U.S. Application Data
(60) Provisional application No. 61/313,725, filed on Mar. 13, 2010.

(51) Int. Cl. G06F 15/00

(52) U.S. Cl. 358/1.15

(57) ABSTRACT

A craft kit, including computer software for the conversion of arbitrary digital images into printable coloring book line drawings, a medium to be used as pages upon which the converted images may be printed through the use of a home computer and printer, and a binding means for binding those pages into a book.

### CROSS-REFERENCE TO RELATED APPLICATIONS

This application claims the benefit of U.S. Provisional Application No. 61/313,725 filed Mar. 13, 2010. The entire disclosure of this application is incorporated herein by reference.

### FIELD OF INVENTION

The invention relates generally to coloring books and more particularly to a craft kit for producing coloring books.

### BACKGROUND OF INVENTION

Coloring is a preferred activity for children and adults alike. Children, in particular, enjoy coloring exercises and coloring in coloring books. In addition to traditional, commercially available coloring books, a wide variety of coloring book style images are available on the internet which may be downloaded and printed for hand coloring.

The creation of coloring books and coloring book style images from arbitrary digital images, such as photographs, is known. For example, U.S. Patent Publication 2008/028479 A1 (Bressen et al.) discloses a method for processing a color digital image to obtain an image resembling those typically found in coloring books; line-art images consisting of closed regions, clearly discriminated from each other, but maintaining the semantic properties of the original photograph.

A similar system for converting photographs into line images for coloring is taught in U.S. Pat. No. 6,356,274 B1 (Spectator). The disclosure also teaches the inclusion in the software of a digital library of images of famous paintings. Users may select images from this library for conversion into line drawings. In addition, this patent teaches a software function whereby numbers are assigned to distinct “color regions” in the line drawing, and these numbers correspond to numbers in a “color key.” By coloring each region according to the colors prescribed in the color key, the system facilitates the reproduction of a colored image representing the color distribution in the original image.

While the above mentioned disclosures discuss methods for the conversion of digital images into line images for printing and hand coloring, the result of the disclosed systems is loose coloring pages, and not coloring books of the kind traditionally used by children.

U.S. Patent Publication 2008/0070199 A1 (Sommer) discloses a system whereby coloring books are produced from the personal photographs of clients. Clients email their photographs to a commercial manufacturer who converts them, with image conversion software, into coloring book style images. Simple captions may also be imposed on the images, and the images are printed and bound by the manufacturer into a traditional coloring book. The final product is then delivered to the client. Accordingly the client turns over the creation of the coloring book to a manufacturer.

Production of a coloring book from digital photos is also discussed in U.S. Patent Publication 2002/0003631 A1 (Abram et al.). This publication discloses a method for the conversion of photos, as well as the assignment of numbers to indexed color regions, with software accessed through a computer terminal located at a public kiosk. The system results in the production of a bound coloring book generated from the photos uploaded by the user at the kiosk. As with Sommer, another entity (not the customer) is entrusted with the production of the book.

These above systems do not target the craft production of coloring books at home. While software for the conversion of digital images into digital coloring book style images is available for home use, a home based system for constructing these images into a bound coloring book does not appear in the prior art.

### SUMMARY OF THE INVENTION

In view of the foregoing, an object of this invention is to provide a craft kit, including computer software for the conversion of arbitrary digital images into printable coloring book line drawings, a medium to be used as pages upon which the converted images may be printed through the use of a home computer and printer, and a binding means for binding those pages into a book.

More particularly, an object of this invention is to provide a system whereby digital images are converted into digital line drawings by way of an image conversion computer software application, where those line drawings may be printed, through the use of a home printer, onto perforated pages, and where those pages may then be bound together into a coloring book through the use of an included binding means designed to securely engage the perforations in the pages.

The kit may also include coloring means [50] such as for example crayons (wax and/or pencil), markers, paints and brushes, etc.

In one embodiment of the present invention, the included software application may automatically convert digital images, including, but not limited to photographs taken by the user, into coloring book style line drawings. The software application may also offer image editing functionality including but not limited to an image formatting function, a function to adjust the contrast of the converted images, a function to impose borders on the converted images, and a function to erase unwanted elements from the converted images so as to facilitate the perfection or modification of the final coloring book pages.

The software application in another embodiment of the invention may include a number of pre-written fantasy stories which may be printed on, or printed along with the converted line drawing images. These stories may be divided into segments, allowing users to print different parts of the stories on different pages, complimenting minoring or accompanying images. In a preferred embodiment, the included fantasy stories will also be customizable, allowing users to make changes to such elements as the names and details of the stories.

The software application may include a function allowing users to add original text to the line drawing images in addition or as an alternative to the pre-written fantasy stories.

The software application may include clipart with the ability to import clipart images onto an open image canvas to add features to images.

Another preferred embodiment of the software application includes a function allowing users to save and edit customized stories and images for future use.

In one embodiment of the present invention, the craft kit would include clear plastic page protectors which may be used to cover the plastic line drawings before binding. The clear plastic page protectors may be compatible with wet or dry erase markers or other erasable marking implements, thereby allowing for indefinite reuse of the assembled coloring book.

In addition to the design and production of craft coloring books, the present invention may also be used for other purposes such as, but not limited to, the design and production of craft calendars, wedding books, and educational tools.

### BRIEF DESCRIPTION OF THE DRAWINGS

Features and advantages of the present invention will be apparent to one skilled in the art in light of the following detailed description in which:

FIG. 1 shows a top plan view of one of the pages containing perforations along one side;

FIG. 2 shows an elevation view of a coil binding means, being one preferred embodiment of the binding means included in the kit;

FIG. 3 shows a top plan view of a software application disk, being one preferred embodiment of a machine readable substrate capable of causing a machine to execute the included software application, and which may as such be included as part of the kit as a preferred medium for the included software;

FIG. 4 shows a perspective view of a clear perforated page protector, being one preferred embodiment of a clear plastic page protector;

FIG. 5 shows one exemplary representation of a complete and assembled coloring book according to embodiments herein;

FIG. 6 shows a perspective view of a perforated page upon which a converted line drawing image has been printed being inserted into a perforated clear plastic page cover;

FIG. 7 shows a perspective view of a coil binding in the process of being wound through the perforations in a number of aligned perforated pages, binding said pages into a completed coloring book.

FIG. 8 shows an exploded view of one embodiment of a craft coloring book kit according to the present invention.

### DETAILED DESCRIPTION

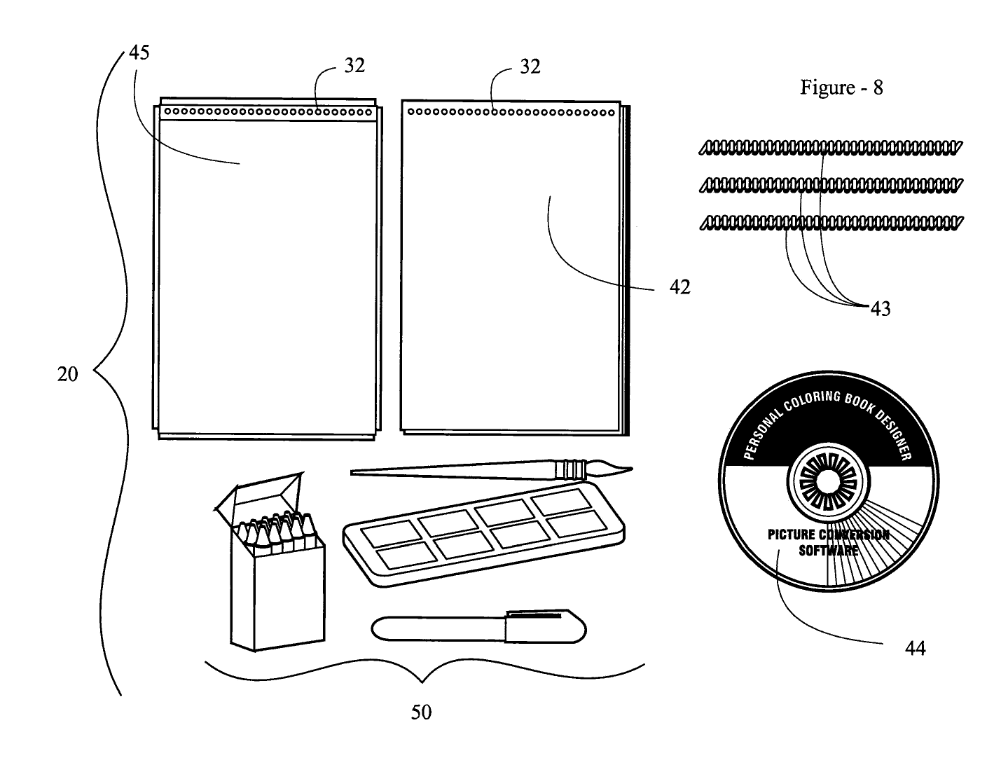

FIG. 8 depicts one embodiment of a kit [20] according to the present invention, including multiple pages [42] containing perforations [32] arranged to receive pre-formed, coil binding means, multiple transparent plastic page protectors [45], also containing perforations [32] arranged to align with the perforations in the in the included pages [42], multiple preformed coil binding means [43] and a software application disk [44] to serving as a medium for the included image conversion software.

The kit [20] may optionally include one or more coloring apparatus [50] such as crayons, pencil crayons, markers, paints and brushes, etc. Including coloring apparatus [50] gives the kit more “everything-you-need-in-a-box” appeal.

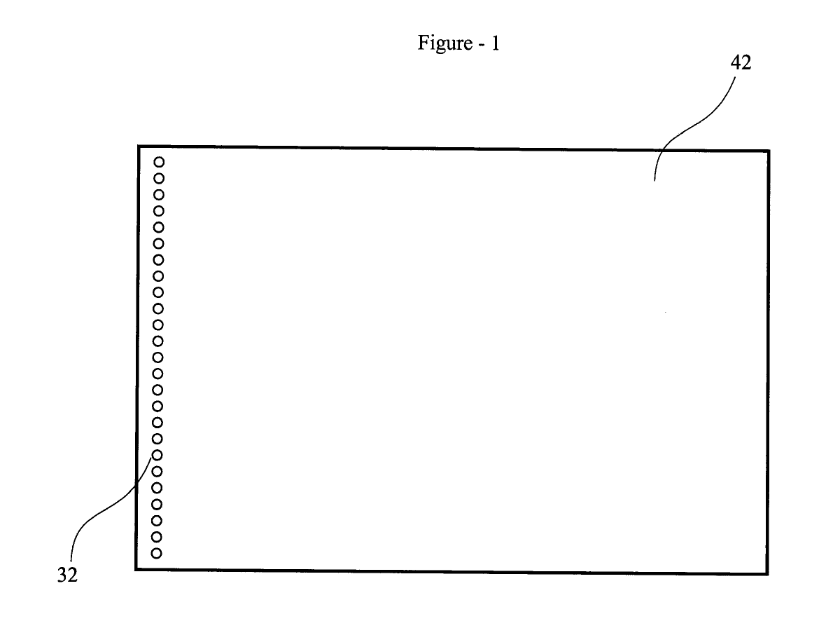

Reference is now made to FIG. 1 where an exemplary representation of an included page is depicted. It is a preferred embodiment of the present invention that the included pages [42] be composed of a paper material compatible for use with home printers including, but not limited to, inkjet and laser printers. As such, the included paper may be inkjet paper, laser paper, photo paper, recycled paper, but is not limited to these.

The included pages [42] may be of any dimension of paper, such as letter, legal, A4, postcard, or index card, but not limited to those.

The included pages [42] may also be of any other material compatible for use with a home printer such as, but not limited to, plastic transparent, translucent, or opaque sheets. In addition, pages of more than one material may be included in an embodiment of the invention, allowing for distinct front and backing pages, as well as distinct interior pages. Possibly stock paper, or non-paper sheets such as plastic material, which are nevertheless printable, might be an alternative, or might be used for cover or backing sheets.

FIG. 1 also depicts perforations [32] in the included pages [42] arranged so as to receive a binding means. The perforations [32] depicted in FIG. 1 are merely representative of one preferred perforation pattern, being a pattern arranged to receive a removable pre-formed coil binding [43]. It will be apparent to those skilled in the art that any number of perforation arrangements may be suited to any number of alternative binding means, and that the present invention is not limited to the exemplary arrangement depicted [32].

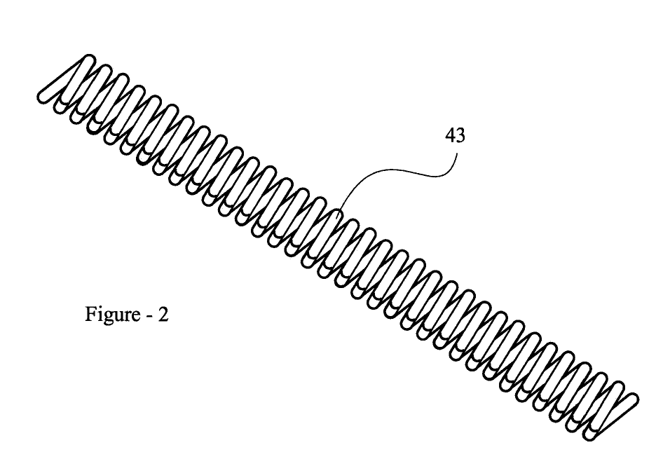

FIG. 2 depicts a “spiral” or “coil” binding means [43], being one preferred binding means which may be included in an embodiment of the present invention, and which is designed to securely engage and bind the loose, printed, perforated pages [42]. It will be apparent to those skilled in the art that any number of alternative binding means are available, including, but not limited to, comb binding means, wire binding means, and adhesives, and that the present invention is not limited to the coil binding depicted in the exemplary representation [43].

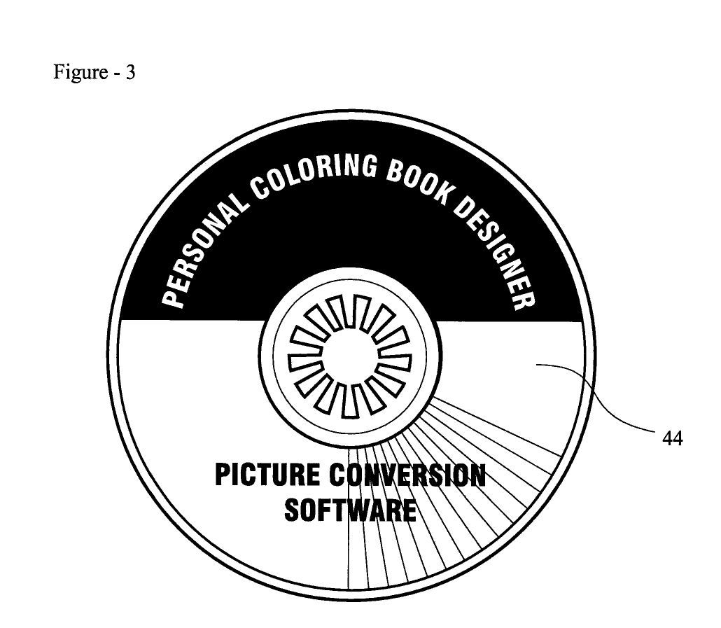

FIG. 3 depicts a software application disk [44], being one preferred embodiment of a machine readable substrate capable of causing a machine to execute the included software application, and which may as such be included as part of the kit as a preferred medium for the included image conversion software. It will be apparent to those skilled in the art that other machine readable substrates capable of causing a machine to execute the included software application are available and may become available, and that the present invention is not limited to the software application disk depicted in the exemplary representation [44].

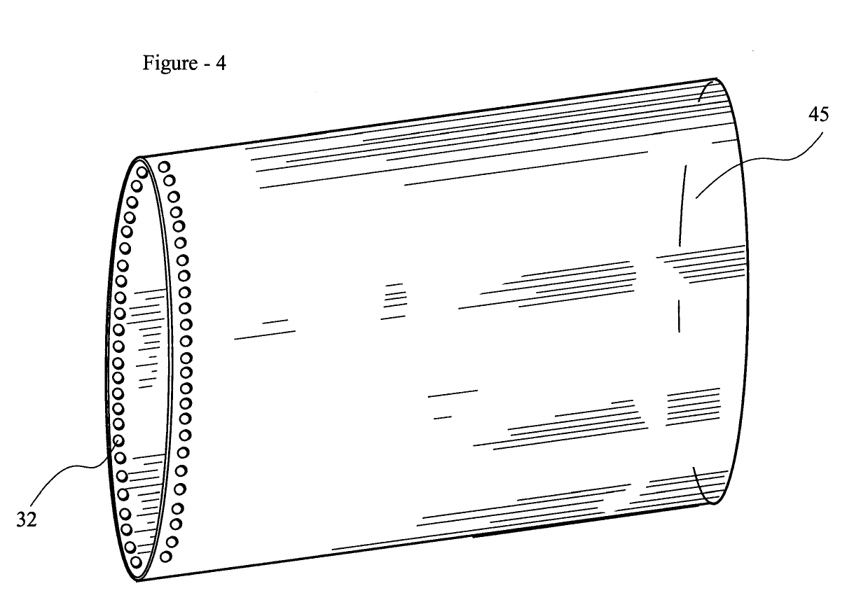

FIG. 4 depicts a clear perforated page protector [45] according to one embodiment of the present invention, but not intended to limit the invention. The transparent perforated page protectors [45] may comprise any type of material that would be compatible with wet or dry erase markers, such as plastic or polypropylene, but not limited to these. The clear perforated page protectors [45] may be of any dimension, but are preferably relative to the corresponding perforated pages [42]. The clear perforated page protectors [45] act as an image preserver to the perforated pages [42] once a coloring image has been converted and printed [36] on to the perforated paper [42], which may allow created coloring books to be used multiple times.

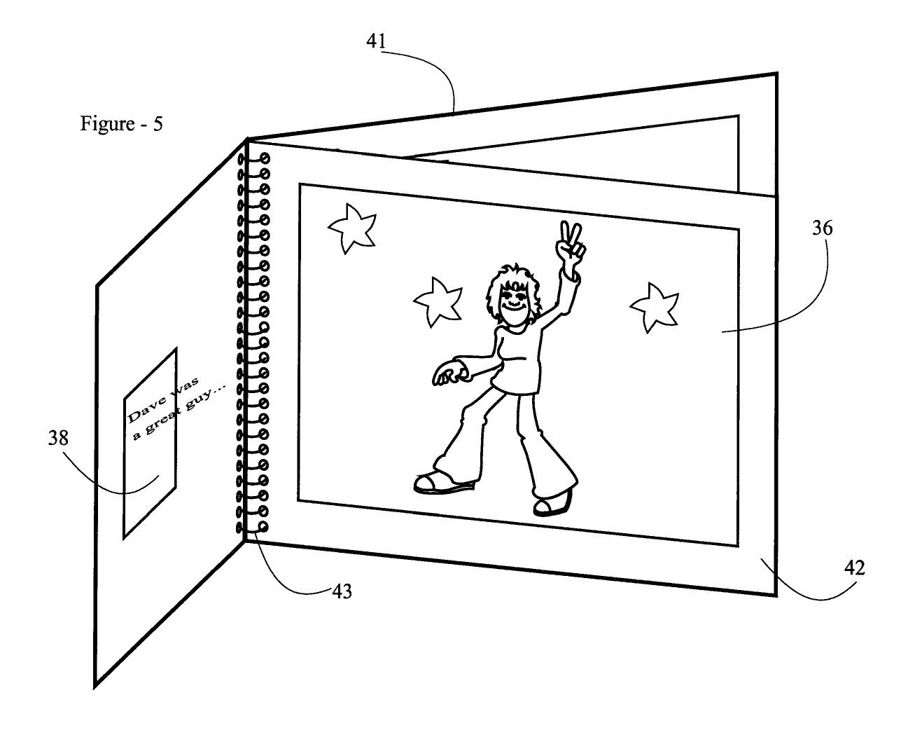

FIG. 5 depicts one example of a created coloring book [41] comprising of a plurality of perforated pages [42] bound together with a coil binding means [43] configured to hold the perforated pages [42] together. A representative converted coloring image is shown printed [36] on a perforated page [42] with a corresponding fantasy story segment depicted as being printed [38] on a page mirroring the printed coloring image [36]. The created coloring book [41] is merely representative of one product of one preferred embodiment of the present invention, and is not intended limit the present invention.

Embodiments of the invention described herein represent a method and a system for the craft design and production of coloring books. Users of the method and system are directed to install the included image conversion software onto a computer through the use of the included machine readable substrate such as a software application disk [44]. Once installed, the included software application allows a user to convert arbitrary digital images into line drawing images, and in various embodiments of the invention, to edit those images in manners such as the manners described above. The converted coloring images may then be printed [36] on the included perforated pages [42] through the use of a computer printer. Segments of fantasy stories included in the software, or edited with the software, or generated through use of the software, may also be printed [38] on the perforated pages [42].

The software application may include clipart with the ability to import clipart images onto an open image canvas for example to add such things as adding hats or glasses to an image.

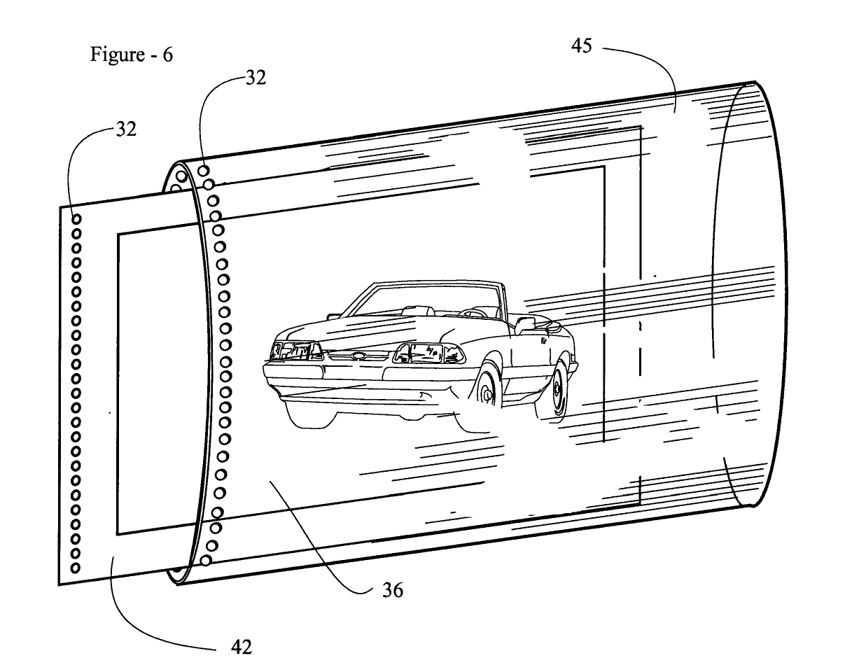

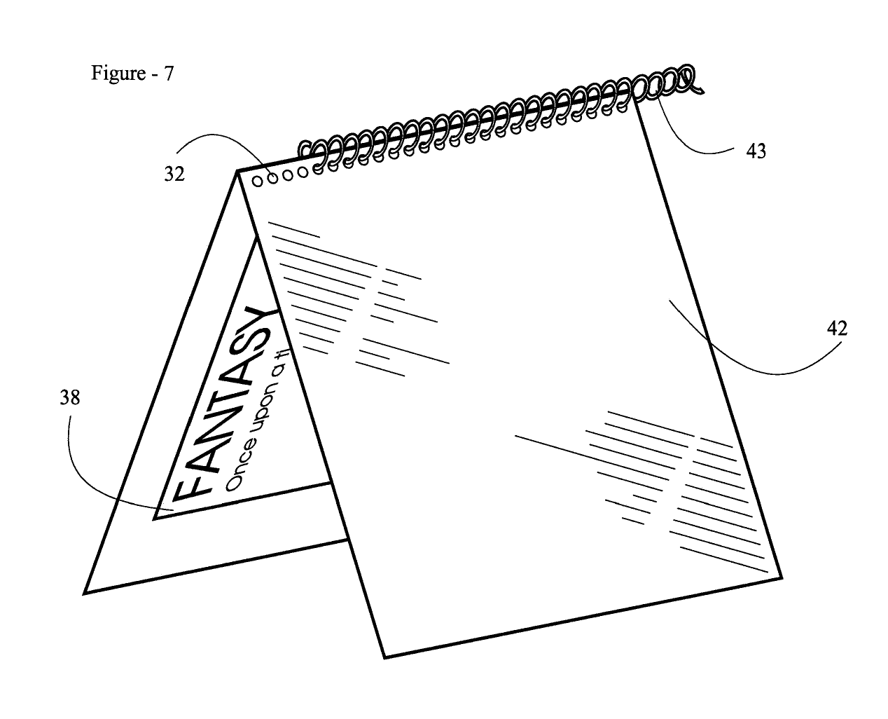

As FIG. 7 depicts, once the perforated pages [42] have been printed, the perforations on the pages [32] may be aligned so as to receive the included binding means [43] which is then manipulated so as to secure the perforated pages into a complete coloring book [41].

Where clear plastic page protectors [45] are employed in the construction of a completed coloring book [41] the page protectors [45] are assigned and attached to the perforated pages [42] prior to those pages being bound together, as is shown in FIG. 6. A page protector is attached to a perforated page [45] so as to allow the perforations [32] in the page protectors [45] to be aligned with the perforations [32] in the perforated pages [42] thereby allowing the page protectors [45] to be bound by the binding means [43] along with the perforated pages [42].

What is claimed is:

1. A craft coloring book design and assembly kit, comprising,
A plurality of individual printable pages;
at least one binding means for binding the pages into a book; and,
computer software for converting digital images into printable line drawing images suitable for use as coloring book style drawings.

2. A craft kit as claimed in claim 1 in which the pages consist of a paper material suitable for use in a home printer, and upon which the line drawings rendered by the software may be printed.

3. A craft kit as claimed in claim 1 in which the pages consist of a plastic material suitable for use in a home printer, and upon which the line drawings rendered by the software may be printed.

4. A craft kit as claimed in claim 1 in which the loose pages consist of multiple different materials suitable for use in a home printer, and upon which the line drawings rendered by the software may be printed.

5. A craft kit as claimed in claim 1 in which the software is stored on a machine readable substrate capable of causing a machine to execute the included software application, and which may as such be included as part of the kit as a preferred medium for the included software.

6. A craft kit as claimed in claim 1 in which the software is accessible over the internet by following instructions provided in the physical kit.

7. A craft kit as claimed in claims 5 and 6 in which the included software automatically converts digital images into digital line drawing images.

8. A craft kit as claimed in claims 5 and 6 in which the included software has image editing functionality;

9. A craft kit as claimed in claims 5 and 6 in which the included software includes a library of pre-loaded images.

10. A craft kit as claimed in claims 5 and 6 in which the included software has image sorting, storing, and retrieval functionality.

11. A craft kit as claimed in claims 5 and 6 in which the included software includes pre-written fantasy stories which may be printed in segments on, or along with, the converted line drawing images.

12. A craft kit as claimed in claims 5 and 6 in which the pre-written fantasy stories included in the software are customizable, allowing users to change names and details in the stories.

13. A craft kit as claimed in claims 5 and 6 in which the included software includes a function allowing users to create original, segmented stories which may be printed on, or along with the converted line drawing images.

14. A craft kit as claimed in claims 2 and 4 which includes a number of clear plastic page protectors for use in covering the printed pages, and upon which wet or dry erase markers or other erasable coloring elements may be used for coloring the images, thereby allowing for reuse of the coloring book.

15. A craft kit as claimed in claim 1 wherein said binding means is a binding coil and said pages are perforated to receive said binding coil.

16. A craft kit according to claim 15 further including at least one page of stock heavier than the remaining of said pages for use as a cover for said book.

17. A craft kit according to claim 9 wherein the library of pre-loaded images includes clipart.

18. A craft kit according to claim 1 further including coloring means for applying color to printed images.
